(19) United States
(12) Patent Application Publication
(10) Pub. No.: US 2010/0212268 A1
(43) Pub. Date: Aug. 26, 2010

(54) AUTOMATIC DEVICE FOR WRAPPING DRUG AND FOOD IN CAPSULE

(76) Inventor: Cho Rang Kim, Namyangju-si (KR)

Correspondence Address: CANTOR COLBURN, LLP, 20 Church Street, 22nd Floor, Hartford, CT, 06103, US

(21) Appl. No.: 12/678,658

(22) PCT Filed: Sep. 17, 2008
(86) PCT No.: PCT/KR2008/005470

§ 371 Date: Mar. 17, 2010

(30) Foreign Application Priority Data
Sep. 21, 2007 (KR) 10-2007-0096665
Aug. 27, 2008 (KR) 10-2008-0083823

(51) Int. Cl. A61J 3/00

(52) U.S. Cl. 53/554

(57) ABSTRACT

Disclosed is a device for automatically wrapping medicine which is hard to eat or food stuff in a unit which is convenient to eat, and also crushing fruits, vegetables and the like and automatically wrapping crude juice extracted from the crushed fruits and vegetables into a capsule. According to this, a user does not have to make an excessive amount of capsule products at one time and preserve the products for a long time even passing a proper expiration date. Thus, the automatic wrapping device is very useful in that the user can directly crush and eat food and medicine as desired and the capsule products can be kept fresh.

### TECHNICAL FIELD

The present invention relates to a automatic device for wrapping drug and food in a capsule, and more particularly to a device capable of automatically wrapping medicine or food stuff which is hard to eat in a unit for convenient eating, and also crushing fruits, vegetables and the like and automatically wrapping crude juice extracted from the crushed fruits and vegetables into a capsule.

### BACKGROUND ART

In general, soft capsules have been used to wrap medicine or food therein. More particularly, oily substances containing medicinal substances can be wrapped in a soft capsule such as a gelatin capsule.

The soft capsule is made in the form of a film containing a water-soluble medicinal substance. For example, the soft capsule can be made of gelatin. More particularly, the soft capsule is formed by adding a general additive to a film material including a coloring agent, a plasticizer, a preservative, a humectant, a solubilizer, a disintegrating agent, a flavoring agent, an anti-oxidant and so forth. In case that the medicinal substance is not easily dissolved in the film material, the solubilizer can be optionally used.

There is an increasing need for varying the materials of the soft capsule according to types of the medicines, while still using conventional soft capsules.

Additionally, there is required a technology enabling users to conveniently eat some hardly edible medicines, for example, extremely bitter or smelly medicines, or abominable food such as an extract of plants or insects, by putting those medicines or food in a soft capsule.

### DISCLOSURE OF INVENTION

### Technical Problem

Therefore, the present invention has been made in view of the above problems, and it is an object of the present invention to provide a device for crushing medicine or food to eat, thereby separating an extract of the medicine or food, and automatically wrapping the extract in a capsule, all conveniently even at home.

It is another object of the present invention to provide a device for automatically wrapping medicine and food in a capsule, enabling convenient eating of abominable medicine by wrapping the medicine in a capsule and convenient preservation of food.

### Technical Solution

In accordance with an aspect of the present invention, the above and other objects can be accomplished by the provision of a device for automatically wrapping medicine and food in a capsule, comprising a supply unit which includes a nozzle for supplying medicine or food, a wrapping roller which wraps a soft capsule film, a horizontal adhering unit which includes left and right first rollers to adherently seal both lateral sides of the soft capsule film, a vertical adhering unit which includes adhering plates to adherently seal upper and lower sides of the soft capsule film after sealing of the lateral sides, a shaping unit which includes left and right second rollers each comprising a shaping recess and line cutters, so as to form the soft capsule film being sealed at the lateral sides and the upper and lower sides into a desired shape, and a control unit which controls a collecting roller collecting a waste soft capsule film remaining after the shaping operation by the shaping unit, storage of the shaped capsules, an operation time, and a manufacturing amount. Here, the supply unit further includes a crushing and extracting unit that comprises a rubber clutch and a motor mounted to a main body of the device, an extracting tub mounted in an outer tub to perform an extracting operation, a crushing blade having a rubber clutch operated in engagement with the rubber clutch of the main body, to perform a crushing operation, an upper lid including a penetration hole to put in materials to be crushed, and a pushing shaft pushing the materials being crushed to enhance the crushing operation.

Thus, the automatic wrapping device includes a crushing and extracting unit capable of crushing materials including fruits, vegetables and medicinal stuffs, separating an extract from the materials, and wrapping the extract in a capsule.

### ADVANTAGEOUS EFFECTS

According to the device automatically wrapping medicine and food in a capsule in accordance with the embodiment of the present invention, medicine and food which are hard to eat can be conveniently put in a soft capsule at home or in a hospital. Furthermore, it becomes easier to crush fresh fruits, vegetables and so on and extract crude juice from them.

In addition, by using the automatic wrapping device, a user does not have to make an excessive amount of capsule products at one time and preserve the products for a long time even passing a proper expiration date. Therefore, the automatic wrapping device is very useful in that the user can directly crush and eat food and medicine as desired and the capsule products can be kept fresh.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a automatic device for wrapping drug and food in a capsule, according to an embodiment of the present invention;

FIG. 2 is a partially-cut perspective view showing the structure of the automatic device for wrapping drug and food in a capsule;

FIG. 3 is a perspective view showing a horizontal adhering unit of the automatic wrapping device according to the embodiment of the present invention;

FIG. 4 is an exploded perspective view showing a vertical adhering unit of the automatic wrapping device according to the embodiment of the present invention;

FIG. 5 is an assembled perspective view showing a shaping unit of the automatic wrapping device according to the embodiment of the present invention;

FIG. 6 is a view for illustrating the manufacturing processes of the automatic wrapping device according to the embodiment of the present invention;

FIG. 7 is a perspective view of a device for automatically wrapping medicine and food in a capsule, further provided with crushing and extracting functions, according to another embodiment of the present invention;

FIG. 8 is a partially-cut longitudinal sectional view of the automatic wrapping device;

FIG. 9 is an exploded perspective view of the automatic wrapping device according to the another embodiment of the present invention; and

FIG. 10 is a sectional view of the automatic wrapping device according to the another embodiment, in which an extracting tub is rotatably mounted in an outer tub.

### BEST MODE FOR CARRYING OUT THE INVENTION

Hereinafter, exemplary embodiments of the present invention will be described in detail with reference to the accompanying drawings.

The following description mainly relates to a device for automatically wrapping a small dose of medicine, food and the like which are hard to eat, in a capsule at home or in a hospital.

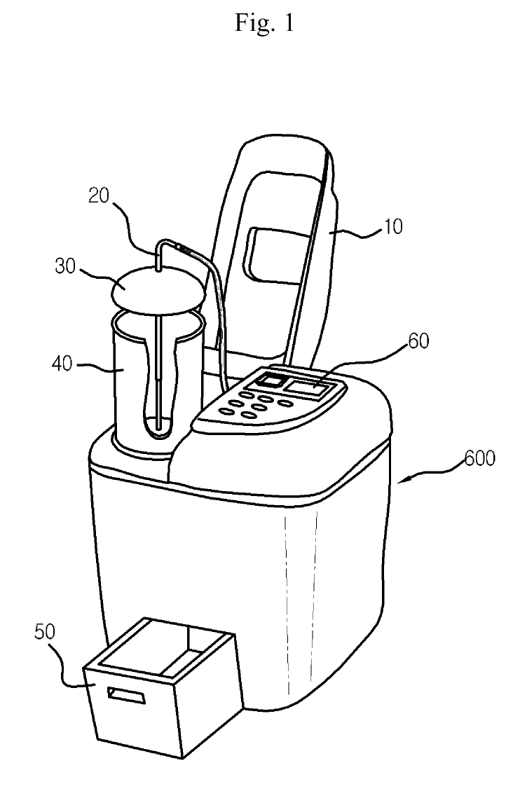

The automatic wrapping device shown in FIG. 1 through FIG. 6 according to one embodiment of the present invention, comprises a supply unit that puts medicine or food in a receptacle 40 through an inlet part and supplies the medicine or food to a nozzle 480. The automatic wrapping device further comprises wrapping rollers 70 and 80 that roll a soft capsule film, a horizontal adhering unit 250 including left and right first rollers 170 and 180 for adherently sealing lateral sides of the soft capsule film, a vertical adhering unit 260 including adhering plates 190 and 190-1 for adherently sealing upper and lower sides of the soft capsule film after the sealing of the lateral sides by the horizontal adhering unit 250, a shaping unit 410 including left and right second rollers 320 and 400 formed with shaping recesses 300 and 350, respectively, to mold the soft capsule film into a desired shape after sealing of the lateral sides and the upper and lower sides, a collecting roller 500 that collects a waste soft capsule film remaining after the shaping, a storage case 50 that stores the shaped capsule products, and a control unit 60 that sets the operation time and the manufacturing amount.

A main body 600 of the automatic wrapping device is structured such that the receptacle 40 can be mounted and dismounted by opening a cover 10. The control unit 60 is disposed at an upper part of the main body 600, to be firm and convenient to use according to an ergonomic design.

The supply unit includes a hose 20 with a straw for conveying liquid received in the receptacle 40. The hose 20 is in connection with a pump 440 so that the liquid is forcibly conveyed. In addition, an auxiliary inlet 520 is formed at an upper part of the pump 440, and a conveying screw 450 is formed in a pipe part, being extended up to the nozzle 480 such that the liquid is conveyed along the conveying screw 450. Here, the auxiliary inlet 520 is used when supplying only a small amount of material or a powdery material. A nozzle unit comprises the nozzle 480, a selection valve 470, and a nozzle controller 490 that controls discharging and supplying operations and interruption of the selection valve 470.

The discharging operation refers to a washing mode for discharging residual substances attached in the nozzle 480 to the outside. When the selection valve 470 is set to the discharging operation by the nozzle controller 490, discharge of the residues is performed through an outlet 460.

Also, the nozzle controller 490 controls conveyance of the soft capsule film and simultaneously controls an amount of the liquid being supplied from the nozzle 480.

The wrapping rollers 70 and 80 are formed on both sides to roll the soft capsule film. The wrapping rollers 70 and 80 are detachable for replacement since being expendable.

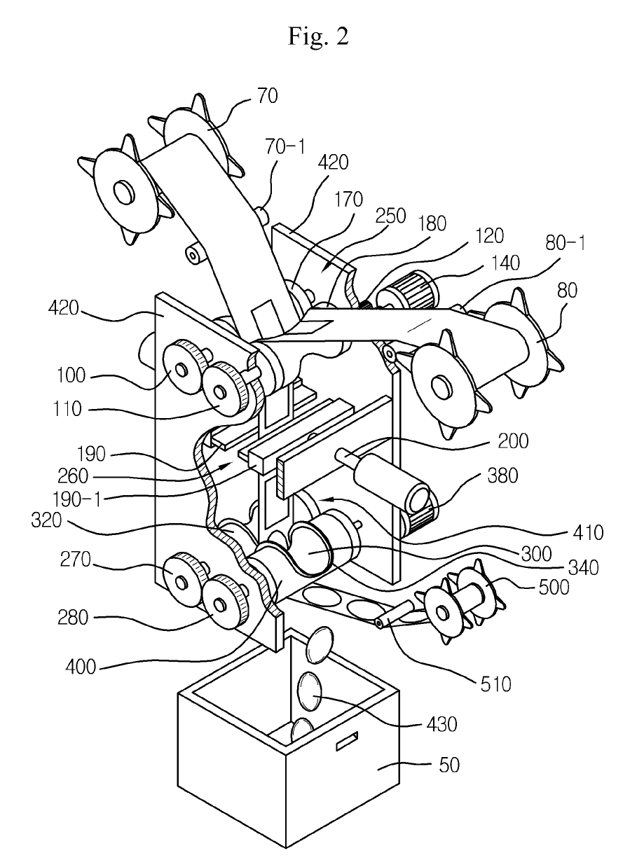

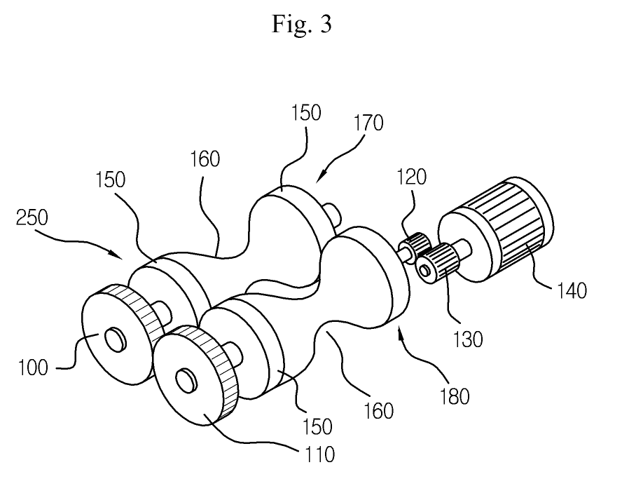

Referring to FIG. 2 and FIG. 3, the horizontal adhering unit 250 is fixed to a frame 420, comprising the left first roller 170, the right first roller 180, and a motor 140.

The left first roller 170 constitutes a gear 100 and includes film adhering surfaces 150 on both sides to adherently seal the lateral sides of the soft capsule film. In addition, an injection recess 160 is formed in the center of the left first roller 170, such that the liquid being injected from the nozzle 480 can be received while tightly sealing the lateral sides.

The right first roller 180 constitutes a gear 110 rotated in engagement with the gear 100 of the left first roller 170, also including an injection recess 160. The right first roller 180 further comprises a motor shaft gear 130 disposed on the opposite side to the gear 110 and rotated in engagement with a first roller gear 120, and the motor 140 for driving the left and right rollers 170 and 180.

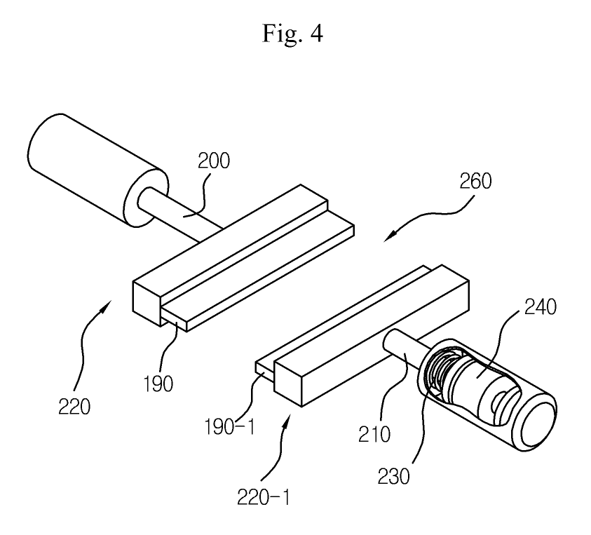

Referring to FIG. 4, the vertical adhering unit 260 is provided to seal the upper and lower sides of the soft capsule film. To this end, in the vertical adhering unit 260, the adhering plates 190 and 190-1 for adhesion of the soft capsule film each comprise a return spring 230 and a solenoid 240, and are operated in a reciprocating motion in connection with rods 200 and 210, respectively.

In a state where the adhering plates 190 and 190-1 connected respectively with the rods 200 and 210 are separated from each other by the return spring 230, when power is applied, the solenoids 240 push the adhering plates 190 and 190-1 toward each other. Therefore, the adhering plates 190 and 190-1 are brought in contact and then separated, and according to this, two sheets of the soft capsule film are adhered. Additionally, as the left and right first rollers 170 and 180 are moved, thereby pulling the soft capsule film, the solenoids 240 operate again to move the adhering plates 190 and 190-1. As the adhering plates 190 and 190-1 are repeatedly reciprocated, the lateral sides of the soft capsule films can be sealed.

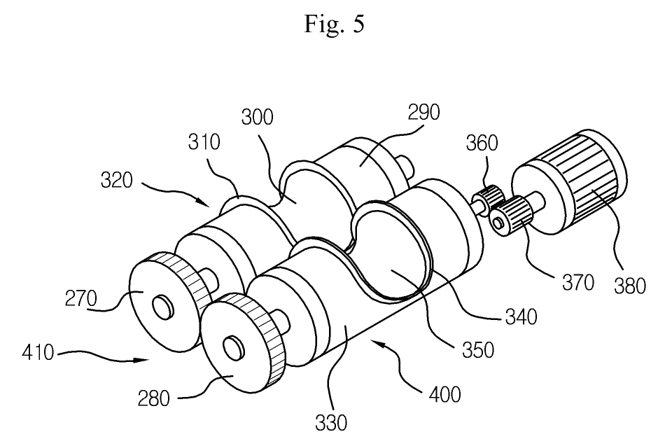

As shown in FIG. 5, the automatic wrapping device then performs shaping of the soft capsule film of which the lateral sides and the upper and lower sides are sealed, into a shape convenient for eating.

The shaping unit 410 comprises the left second roller 320, the right second roller 400, gears 270 and 280, a second roller gear 360, a motor shaft gear 370, and a motor 380.

The left second roller 320 includes contacting surfaces 290 on both sides thereof, and a shaping recess 300 in the center. In addition, a line cutter 310 is formed along a circumferential edge of the shaping recess 300. A gear 270 is further comprised to rotate in engagement with a gear 280 of the right second roller 400.

The right second roller 400 includes the gear 280 rotated in engagement with the gear 270 of the left second roller 320, a shaping recess 350, and a line cutter 340 formed along a circumferential edge of the shaping recess 350. The right second roller 400 further comprises the motor shaft gear 370 rotated in engagement with the second roller gear 360, and the motor 380, which are disposed at the opposite side to the gear 280.

Here, rollers having other various shapes can be adopted so that a user can produce the capsule in a desired shape.

The collecting roller 500, being disposed at the end of device, collects the waste soft capsule film being cut out as passing through a guide roller 510.

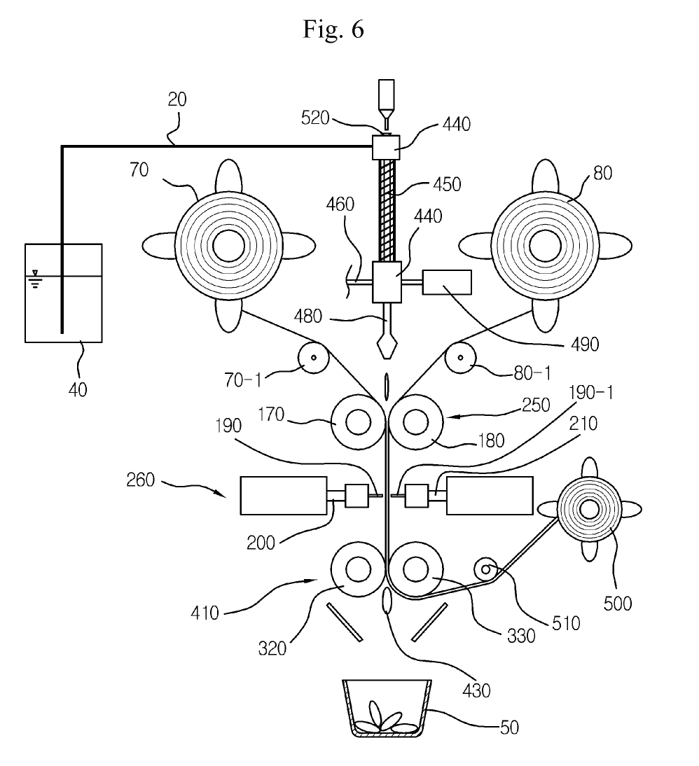

Hereinafter, the operations of the automatic wrapping device will be described with reference to the manufacturing flow diagram of FIG. 6.

First, the medicine or food is put in the receptacle 40 and the cover 10 is closed. Through the control unit 60, the power is turned on and the number of capsules and the operation time are set. According to this, the pump 440 is rotated and the motors 140 and 380 are simultaneously rotated, thereby rotating the respective first and the second rollers 170, 180, 320 and 400. After the left and right first rollers 170 and 180 are rotated, the solenoid 240 of the vertical adhering unit 260 is operated such that the adhering plates 190 and 190-1 are brought into contact with each other, thereby sealing the soft capsule films. When the soft capsule film is moved by a predetermined distance, the adhering plates 190 and 190-1 are operated again to adherently seal the upper and the lower sides of the soft capsule films.

After sealing of the upper and the lower sides, the shaping unit 410 rotates the left and the right second rollers 320 and 400. Accordingly, a capsule 430 is produced in an easily edible form by the line cutters 310 and 340 and the shaping recesses 300 and 350 are formed at the respective rollers 320 and 400. During this, the waste soft capsule film is collected by the collecting roller 500 while the completed capsules 430 are collected and stored in the storage case 50.

In case of wrapping powdery stuff or a small amount of medicine or food in a capsule, the auxiliary inlet 520 is used to produce the capsules by only the required amount. Especially for wrapping of the powder, the conveying screw 450 is provided at the pipe part to promote conveyance of the powder.

Preferably, a sensor may be mounted to the respective parts so that manufacturing of the capsules can be performed according to predetermined programs in more various manners. Furthermore, hot wires may be added to the rollers or the adhering plates 190 and 190-1 such that the soft capsule films can be adhered to each other more easily.

The automatic wrapping device according to this embodiment has only an extracting function since the medicine or the extract of food needs to be prepared directly by the device. However, both crushing and extracting functions can be provided to the automatic wrapping device

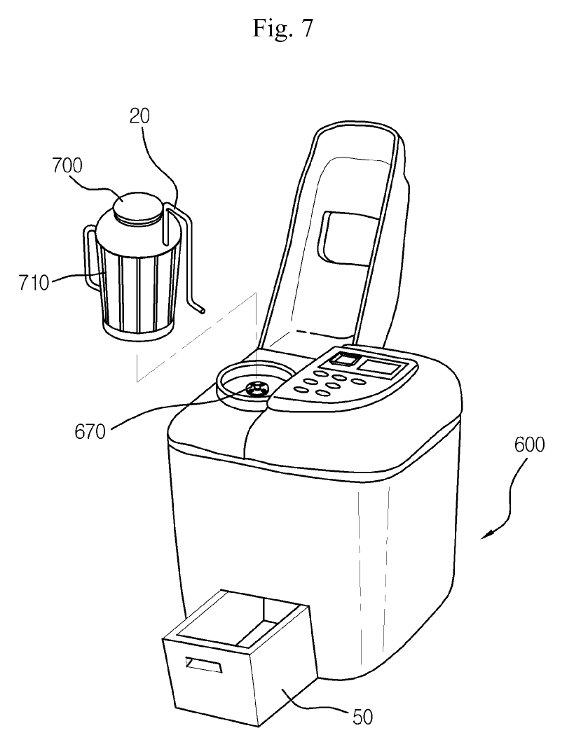

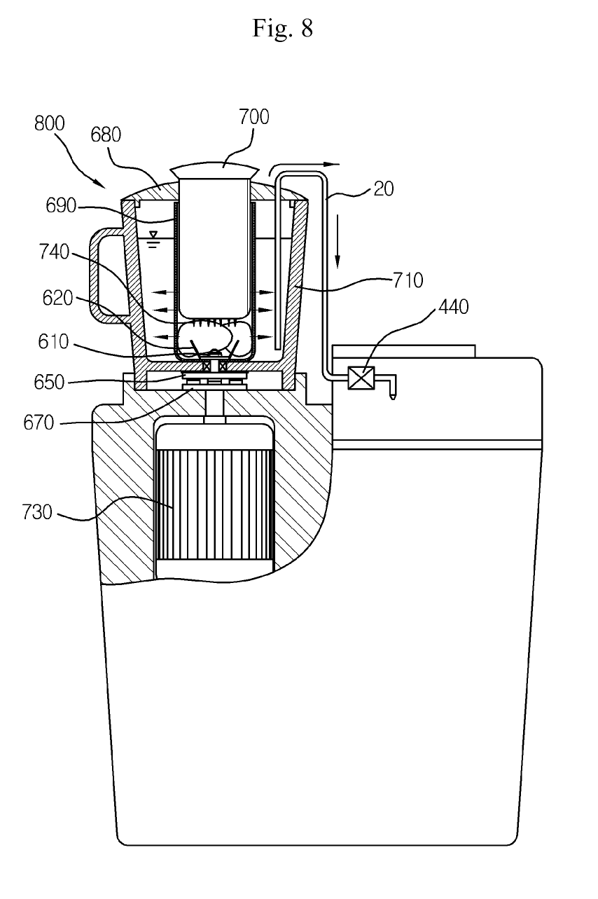

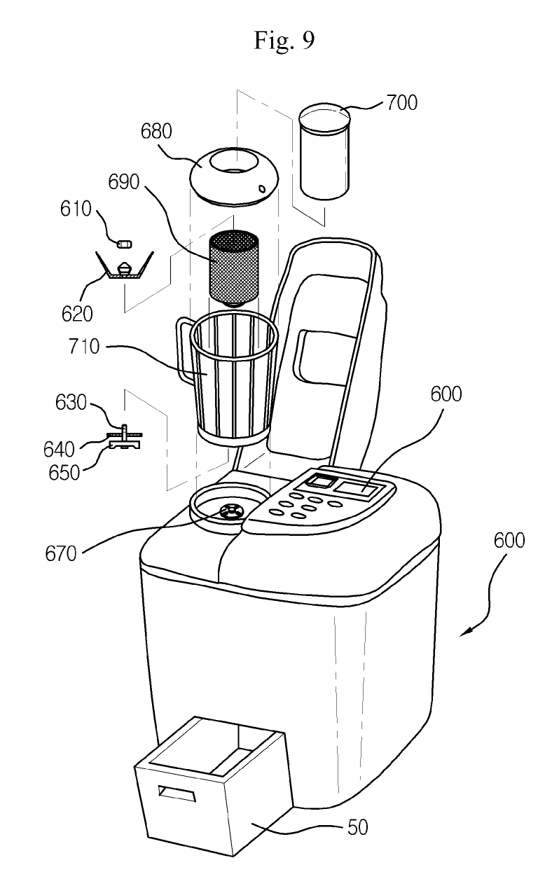

FIG. 7 through FIG. 10 illustrates a device for automatically wrapping medicine and food in a capsule, according to another embodiment of the present invention.

In the present embodiment, structures for performing crushing and extracting are provided at one side of an upper part of the main body 600 as follows.

A built-in motor 730 is detachably mounted to the upper part of the main body 600. A rubber clutch 670 is mounted at an upper part of a shaft of the motor 730 to transmit rotative power of the motor 730.

A rubber clutch 650 is provided at a lower part in an outer tub 710 to be rotated in engagement with the rubber clutch 670.

The supply unit comprises the rubber clutch 670 and the motor 730 for power transmission. The rubber clutch 670 is formed with protrusions to prevent a slip.

In addition, an extracting tub 690 and a crushing blade 620 are provided in the outer tub 710. Therefore, the crushing and extracting can be performed through connection between the rubber clutch 670 of the main body 600 and the rubber clutch 650 formed at the crushing blade 620. More specifically, the crushing and extracting operations are performed within the outer tub 710 as follows.

The extracting tub 690 is connected to the rubber clutch 650 through a shaft bolt 630 so that the shaft bolt 630 and the crushing blade 620 are rotated together. Since the outer tub 710 and the extracting tub 690 are fixed to each other, only the crushing blade 620 is rotated in the extracting tub 690. Here, a bearing may be inserted between the outer tub 710 and the shaft bolt 630 to reduce friction. However, a casing can be used instead to restrain an increase of cost.

The shaft bolt 630 is mounted to the rubber clutch 650, and a packing 640 and the outer tub 710 are connected to the shaft bolt 630. The extracting tub 690 is connected above the shaft bolt 630 which is connected in the outer tub 690. Next, the crushing blade 620 is fixed using a nut 610.

With the above structure, the crushing of the medicine or food can be performed in the extracting tub 690.

An upper lid 680 is mounted to an upper part of the outer tub 710. The upper lid 680 is formed with a penetration hole to put materials to be crushed therethrough. Also, a pushing shaft 700 is provided to push the materials being crushed in the extracting tub 690.

When the pushing shaft 700 is driven in after the crushing operation is performed, the extract, for example, crude juice of fruits, is discharged through lateral sides of the extracting tub 690, being separated from dregs of the crushed materials, such as fibers of the fruits. Therefore, the supply unit is capable of obtaining contents of the capsule by thus crushing and dehydrating the materials such as fruits. In addition, the pushing shaft 700 includes protrusions 740 so that the materials can be more easily crushed without idly rotating.

Thus-produced extract is supplied to the supply unit through the hose 20. The extract can be forcibly conveyed by the pump 440 mounted to the hose 20.

Thus, the extract is supplied into the automatic wrapping device through the hose 20.

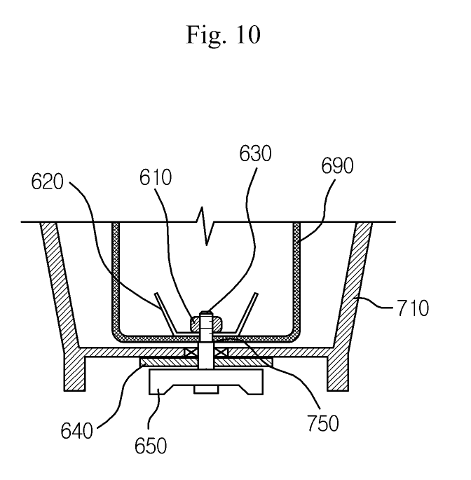

As shown in FIG. 10, according to another embodiment of the present invention, the extracting tub 690 is rotatably mounted in the outer tub 710. This structure will be described in greater detail below.

Power transmission is performed through the rubber clutch 670 and the motor 730 to the upper part of the main body. The rubber clutch 670 is formed with the protrusions to prevent a slip. Since the extracting tub 690 and the crushing blade 620 are mounted in the outer tub 710, the crushing operation and the extracting operation can simultaneously be performed by engagement between the rubber clutch 670 of the main body 600 and the rubber clutch 650 of the crushing blade 620. Therefore, the extracting tub 690 can be rotated in the outer tub 710 and the extracting operation can be simultaneously performed.

The shaft bolt 630 connected to the rubber clutch 650 formed at a bottom surface of the outer tub 710 includes a step portion 750 for connecting the extracting tub 690 and rotating along with the shaft bolt 630.

The shaft bolt 630 is mounted to the rubber clutch 650, and the packing 640 and the outer tub 710 are connected to the shaft bolt 630. The extracting tub 690 is connected above the shaft bolt 630 that is connected in the outer tub 690. Next, the crushing blade 620 is fixed using the nut 610.

According to the above structure, the extracting tub 690 can be rotated in the outer tub 710, thereby performing the extracting operation.

More specifically, as the materials to be crushed are put in through the upper lid 680 and pushed by the pushing shaft 700 formed with the protrusions 740, the materials are crushed whereas the extract of the materials is discharged to the outside by a centrifugal force. Accordingly, the crushing and the extracting can be simultaneously performed. Here, the materials can be more efficiently crushed due to the protrusions 740 of the pushing shaft 700.

According to the embodiments of the present invention, powder or liquid materials can be used. Especially, since a crushing and extracting unit 800 is provided, which is capable of performing crushing of the materials including fruits, vegetables and medicinal stuffs and separating the extract from the materials, capsules containing the extract can be produced with ease all in an automated manner.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A automatic device for wrapping drug and food in a capsule, comprising:
a supply unit which includes a nozzle for supplying medicine or food;
a wrapping roller which rolls a soft capsule film;
a horizontal adhering unit which includes left and right first rollers to adherently seal both lateral sides of the soft capsule film;
a vertical adhering unit which includes adhering plates to adherently seal upper and lower sides of the soft capsule film after sealing of the lateral sides;
a shaping unit which includes left and right second rollers each comprising a shaping recess and line cutters, so as to form the soft capsule film being sealed at the lateral sides and the upper and lower sides into a desired shape; and
a control unit which controls a collecting roller collecting a waste soft capsule film after the shaping, storage of the shaped capsules, an operation time, and a manufacturing amount.

2. The automatic wrapping device according to claim 1, wherein the supply unit comprises:
a hose which conveys an input material therethrough;
an auxiliary inlet which supplies other types of materials; and
a conveying screw which is connected with a conveying pump,
wherein the conveying screw includes a selection valve disposed at an end of thereof to control supply and discharge of the material, a check switch, and a nozzle.

3. The automatic wrapping device according to claim 1, wherein the horizontal adhering unit comprises:
the left first roller which includes a gear and an injection recess;
the right first roller which includes a gear rotating in engagement with the gear of the left first roller, and an injection recess;
a motor shaft gear which is rotated in engagement with a first roller gear to thereby rotate the right first roller; and a motor.

4. The automatic wrapping device according to claim 1, wherein the adhering plates of the vertical adhering unit, for adhesion of the soft capsule film, each comprise a return spring and a solenoid to be operated in a reciprocating motion in connection with rods.

5. The automatic wrapping device according to claim 1, wherein the shaping unit comprises:
a left second roller which includes a gear, a shaping recess, and a line cutter formed along a circumference of the shaping recess;
a right second roller which includes a gear rotated in engagement with the gear of the left second roller, a shaping recess, and a line cutter formed along a circumference of the shaping recess;
a motor shaft gear which is rotated in engagement with a second roller gear to thereby rotate the right second roller; and a motor.

6. A device for automatically wrapping medicine and food in a capsule, comprising a supply unit which includes a nozzle for supplying medicine or food; a wrapping roller which wraps a soft capsule film; a horizontal adhering unit which includes left and right first rollers to adherently seal both lateral sides of the soft capsule film; a vertical adhering unit which includes adhering plates to adherently seal upper and lower sides of the soft capsule film after sealing of the lateral sides; a shaping unit which includes left and right second rollers each comprising a shaping recess and line cutters, so as to form the soft capsule film being sealed at the lateral sides and the upper and lower sides into a desired shape; and a control unit which controls a collecting roller collecting a waste soft capsule film remaining after the shaping operation by the shaping unit, storage of the shaped capsules, an operation time, and a manufacturing amount, wherein the supply unit further includes a crushing and extracting unit that comprises:
a rubber clutch and a motor mounted to a main body of the device;
an extracting tub mounted in an outer tub to perform an extracting operation;
a crushing blade having a rubber clutch operated in engagement with the rubber clutch of the main body, to perform a crushing operation;
an upper lid including a penetration hole to put in materials to be crushed; and a pushing shaft pushing the materials being crushed to enhance the crushing operation.

7. The automatic wrapping device according to claim 6, further comprising:
a hose formed between the outer tub and the extracting tub to convey only an extract liquid separated from the materials; and a lid part having a fixing hole for fixing the hose.

8. The automatic wrapping device according to claim 6, wherein the supply unit further comprises:
a nut for fixing the crushing blade rotatably in the extracting tub;
a shaft bolt including a step portion which fixes the extracting tub thereto; and a rubber packing.
